(19) United States
(12) Patent Application Publication
(10) Pub. No.: US 2004/0102955 A1
(43) Pub. Date: May 27, 2004

(54) DVD driver for language study and method of processing audio streams thereof

(75) Inventors: Jun-Ho Choi, Gyeonggi-do (KR); Cheon-Seong Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/715,380

(22) Filed: Nov. 19, 2003

(30) Foreign Application Priority Data
Nov. 26, 2002 (KR) 2002-74128

(51) Int. Cl. G06F 17/20

(52) U.S. Cl. 704/1

(57) ABSTRACT

A method and apparatus to process audio streams that involve displaying a language selection menu, including a plurality of language choices, in a language selection mode, storing the language codes corresponding to multiple languages selected from the language selection menu and enabling one or more audio decoders designated for decoding audio streams that correspond to the language codes, and reading audio streams addressed to the language codes from a predetermined recording area of an optical disk and outputting the read audio streams to their respective audio decoders at the same time.

### CROSS-REFERENCE TO RELATED APPLICATIONS

This application claims the priority of Korean Patent Application No. 2002-74128, filed on Nov. 26, 2002, in the Korean Intellectual Property Office, the disclosure of which is incorporated herein in its entirety by reference.

### BACKGROUND OF THE INVENTION

1. Field of the Invention

The present invention relates to an optical disk system, and more particularly, to a digital video disc (DVD) driver suitable for language study and a method of processing audio streams thereof.

2. Description of the Related Art

A typical DVD has a storage capacity of about 4.7 gigabytes so that it can store a moving picture with audio streams and subtitles in different languages. A maximum of 8 audio streams for each video stream can be recorded on a DVD, and a DVD driver can selectively reproduce one of the audio streams from the DVD.

Such a conventional DVD driver is able to output down-mixed 2CH (R, L) stereo signals and AC-3 or Dolby Digital, 6CH signals, but it generally outputs down-mixed 2CH stereo signals.

The conventional DVD driver, however, is required to select only one language from among a plurality of languages corresponding to a plurality of audio streams recorded on a DVD. For example, a conventional DVD for language study does not allow a user to listen to both Korean and English audio streams at the same time, so the user has to listen to either the Korean or the English audio stream first and then listen to the other audio stream, which is very inconvenient.

### SUMMARY OF THE INVENTION

The present invention provides a DVD driver for language, which enables a user to listen to audio streams in two different languages by outputting different audio streams corresponding to different languages via different channels, i.e., left and right audio channels.

The present invention also provides a method of processing audio streams, which enables a user to listen to audio streams in two different languages.

According to an aspect of the present invention, there is provided a method of processing audio streams of an optical disk driver that drives an optical disk where a video stream of a single channel and audio streams of a plurality of channels are recorded. The method involves displaying a language selection menu, including a plurality of language choices, in a language selection mode; storing language codes corresponding to one or more languages selected from the language selection menu and enabling one or more audio decoders designated for decoding audio streams corresponding to the language codes; and reading audio streams addressed to the language codes from a predetermined recording area of an optical disk and outputting the read audio streams to their respective audio decoders at the same time.

According to another aspect of the present invention, there is provided an optical disk driver that reproduces data from an optical disk where a video stream of a single channel and audio streams of a plurality of channels are recorded. The optical disk driver includes an RF amplification unit which extracts a servo signal and modulated data from an electrical signal generated from a pickup unit; a digital signal processing unit which demodulates the modulated data extracted by the RF amplification unit and separates the demodulated data into audio streams of a plurality of channels and a video stream of a single channel; one or more audio decoding units which separately decode audio streams selected from among the audio streams of a plurality of channels provided by the digital signal processing unit; and a system control unit which calls a language selection menu in response to a language selection key signal, selects one or more language codes, designates audio decoding units corresponding to the selected language codes, reading audio streams corresponding to the selected language codes, and outputting the read audio streams to the corresponding audio decoding units at the same time.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a DVD driver for language study according to an embodiment of the present invention;

FIG. 2 is a detailed block diagram of a signal decoding unit according to an embodiment of the present invention; and

FIG. 3 is a flowchart of a method of processing audio streams of a DVD driver according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

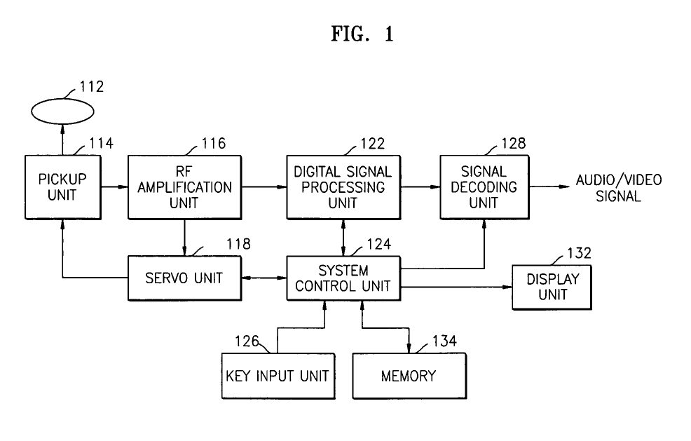

FIG. 1 is a block diagram of a DVD driver for language study according to an embodiment of the present invention. Referring to FIG. 1, a pickup unit 114 reads an optical signal from a disk 112 where data is stored and converts the optical signal into an electrical signal.

An RF amplification unit 116 extracts a servo signal, which is necessary for a servo operation, and modulated data from the electrical signal output from the pickup unit 114.

A digital signal processing unit 122 demodulates the modulated data output from the RF amplification unit 116, corrects errors in the demodulated data, removes additional data from the demodulated data, and separates the resulting demodulated data into audio streams and a video stream in response to a stream control signal output from a system control unit 124. The digital signal processing unit 122 extracts an audio stream corresponding to a language that is selected in response to a language selection control signal output from the system control unit 124.

A servo unit 118 receives information necessary for servo control from the RF amplification unit 116 and the system control unit 124 and stably performs a servo operation.

A signal decoding unit 128 decodes the audio streams and the video stream obtained by the digital signal processing unit 122 in response to a decode command output from the system control unit 124. In addition, the signal decoding unit 128 includes a plurality of audio decoders so that it can decode an audio stream selected by a user that corresponds to a language.

A display unit 132 displays a language selection menu. A user may select multiple languages from the language selection menu using a key input unit 126 on a screen.

A memory 134 stores a program that operates the system control unit 124, language selection menu data, and the decoder designation data.

The system control unit 124 controls the pickup unit 114, the RF amplification unit 116, the digital signal processing unit 122, the signal decoding unit 128, and the display unit 132 in response to commands input by a user using the key input unit 126. The system control unit 124 calls a language selection menu stored in the memory 134 in response to user language selection key inputs from the key input unit 126 and selects language codes corresponding to the user key inputs. The system control unit 124 designates audio decoders that are used to decode audio streams that correspond to the selected language codes, and searches for the audio streams to be decoded in the designated audio decoders.

The key input unit 126 may be multi-language function selection keys provided at the panel of an optical disk device or at a predetermined portion of a remote controller so that the user may make a selection of a language from among a plurality of languages displayed and send a corresponding signal to the system controller 124.

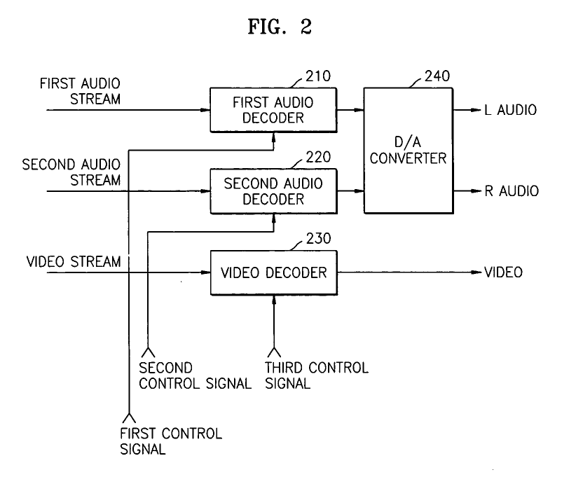

FIG. 2 is a detailed block diagram of the signal decoding unit 128 of FIG. 1. Here, let us assume that a video stream of a single channel and audio streams of a plurality of channels are recorded on a DVD. It is understood that other disk types may be incorporated with the present invention that do not use a video signal including, but not limited to CD-R, CD-ROM, or CD-RW. Such disks could be used with the optical disk driver of the present invention to output multiple audio streams corresponding to different languages simultaneously through different audio channels.

Referring to FIG. 2, a first audio decoder 210 decodes a first audio stream (for example, a Korean audio stream) output from a digital signal processing unit 122 in response to a first control signal.

A second audio decoder 220 decodes a second audio stream (for example, an English audio stream) output from the digital signal processing unit 122 in response to a second control signal.

A video decoder 230 decodes a video stream output from the digital signal processing unit 122 in response to a third control signal and then outputs the decoded video stream in the form of an RGB video signal.

A digital-analog converter 240 converts the audio streams decoded by the first and second audio decoders 210 and 220 into analog audio signals and outputs the analog audio signals to a left channel L and a right channel R, respectively. For example, Korean is output from the left channel L, while English is output from the right channel R.

Therefore, two different languages, for example, Korean and English, are separately decoded by different audio decoders, i.e., the first and second audio decoders 210 and 220, and output via different channels, i.e., the left and right channels L and R.

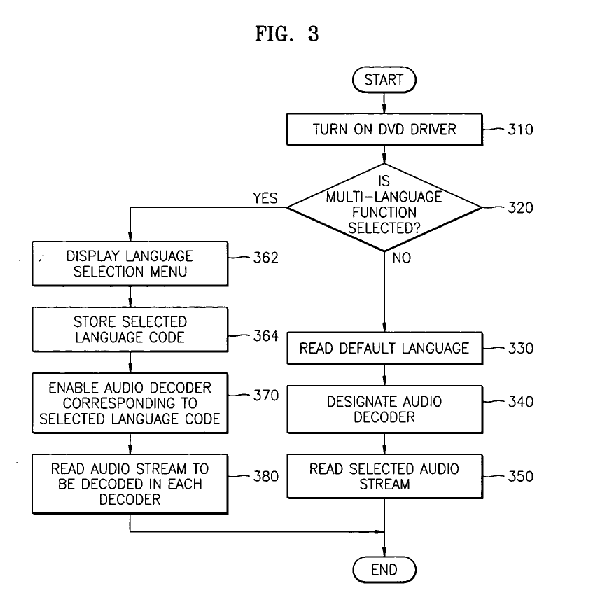

FIG. 3 is a flowchart of a method of processing audio streams of a DVD driver according to an embodiment of the present invention.

When a DVD driver is turned on in operation 310, the DVD driver checks whether a key for a multi-language selection function is selected in operation 320. Different codes are respectively allotted to different languages so that the languages can be distinguished from one another. When the key for a multi-language selection function is selected, a language selection menu is displayed on a screen in operation 362. After a user selects from a list of predetermined languages, corresponding language codes are stored in operation 364. For example, the user may select Korean and English from the language selection menu. Thereafter, audio decoders designated for processing the selected languages, e.g., Korean and English, are enabled at the same time in operation 370. In operation 380, audio streams addressed to the selected language codes are searched for and read from a predetermined recording area of the DVD. Therefore, audio streams are simultaneously output from different audio decoders in two different languages selected by the user (e.g., Korean and English) via different channels.

If the key for a multi-language selection function is not selected, a language designated as the default is read in operation 330. Thereafter, in operation 340, an audio decoder designated for decoding an audio stream corresponding to the language read in operation 330 is selected from among a plurality of audio decoders. In operation 350, only the audio stream corresponding to the language read in operation 330 is read from a predetermined recording area of the DVD.

During reproduction of audio streams in different languages, audio streams can be output louder in one of the different languages than in the others by adjusting the magnitude of each audio signal of a corresponding channel that are separately reproduced through left and right channels.

As described above, the DVD driver of the present invention can be a very efficient tool for users that are learning foreign languages because it can output audio streams in two different languages at the same time. In addition, the DVD driver of the present invention allows viewers to listen to a movie director's commentary on each scene in a movie, which is stored on a DVD along with a movie title, while they are watching the movie. The optical disk driver of the present invention may also be configured to permit audio streams other than languages to be selected and split so that output occurs in separate audio channels. For example, different sounds associated with video games may be selected and output to different audio channels. Additionally, the present invention could permit a user to select an output without a music track accompanying the movie or with an optional music track accompanying the movie.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of processing audio streams of an optical disk driver that drives an optical disk where a video stream of a single channel and audio streams of a plurality of channels are recorded, the method comprising:
displaying a language selection menu, including a plurality of language choices, in a language selection mode;
storing language codes corresponding to a plurality of languages selected from the language selection menu and enabling one or more audio decoders designated for decoding audio streams corresponding to the language codes; and
reading audio streams addressed to the language codes from a predetermined recording area of the optical disk and outputting the read audio streams to their respective audio decoders at the same time to output separate audio stream signals corresponding to the different languages.

2. The method of claim 1, further comprising a default mode, wherein in the default mode, a language designated as a default is selected, an audio decoder corresponding to the default language is designated, and an audio stream corresponding to the default language is decoded using the designated audio decoder.

3. The method of claim 1, further comprising outputting the separate audio stream signals corresponding to the different languages to separate audio channels corresponding to each of the different languages.

4. An optical disk driver that reproduces data from an optical disk where a video stream of a single channel and audio streams of a plurality of channels are recorded, the optical disk driver comprising:
an RF amplification unit which extracts a servo signal and modulated data from an electrical signal generated from a pickup unit;
a digital signal processing unit which demodulates the modulated data extracted by the RF amplification unit and separates the demodulated data into audio streams of a plurality of channels and a video stream of a single channel;
one or more audio decoding units which separately decodes audio streams selected from among the audio streams of the plurality of channels provided by the digital signal processing unit; and
a system control unit which calls a language selection menu in response to a language selection key signal, selects multiple language codes, designates audio decoding units corresponding to the selected language codes, reads audio streams corresponding to the selected language codes, and outputs the read audio streams to the corresponding audio decoding units at the same time.

5. The optical disk driver of claim 4 further comprising a key input unit, which applies a command for voice selection to the system control unit.

6. The optical disk driver of claim 4, further comprising:
a memory storage that interfaces to the system control unit to store the menu of languages and the multiple selected language codes.

7. The optical disk driver of claim 4, further comprising:
a digital to analog converter to convert the digital signals corresponding to the decoded audio streams to analog signals and simultaneously output the signals to separate audio channels.

8. The optical disk driver of claim 4, further comprising:
a display device responsive to the system control unit to display the language selection menu; and
an input device wherein the user selects from the language selection menu and the system control unit designates the audio decoding units corresponding to the user selected languages.

9. A system to reproduce signals from an optical disk comprising:
a pickup unit to read optical signals from the optical disk;
a digital signal processor that separates the signals read from the optical disk into a video stream and a plurality of audio streams;
a signal decoder that simultaneously decodes separate selected audio streams and the video stream; and
a controller that designates the audio streams corresponding to different selections to be decoded by the signal decoder.

10. The system of claim 9, wherein the signal decoder further comprises:
a plurality of audio decoders to digitally decode separate audio streams corresponding to the different designated selections from the optical disk;
a digital to analog converter to convert the digitally decoded audio streams to analog signals and outputs the analog signals simultaneously in separate channels that correspond to separate audio streams; and
a video decoder to decode the video stream from the optical disk and output a video signal.

11. The system of claim 9, further comprising:
an input device that sends a signal to the controller designating different selections in response to a user input.

12. The system of claim 11, further comprising:
a display device to display different selection choices for the user to choose different selections using the input device.

13. The system of claim 12, wherein the selection choices are different languages.

14. The system of claim 12, wherein the selection choices are different musical tracks.

15. The system of claim 12, wherein the selection choices are different sound effects and musical scores.

16. A system to reproduce multiple signals from a disk comprising:
a pickup unit to read signals from the disk;
a digital signal processor that separates the signals read from the disk into a plurality of audio streams;
a signal decoder that simultaneously decodes separate selected audio streams; and
a controller that designates the audio streams corresponding to different selections to be decoded by the signal decoder.

17. The system of claim 16, wherein the signal decoder further comprises:
a plurality of audio decoders to digitally decode separate audio streams corresponding to the different designated selections from the disk;
a digital to analog converter to convert the digitally decoded audio streams to analog signals and outputs the analog signals simultaneously in separate channels that correspond to separate audio streams.

18. The system of claim 17, wherein the digital signal processor separates a video stream from the signals read from the disk.

19. The system of claim 18, wherein the signal decoder further comprises a video decoder that decodes the video stream from the disk and outputs a video signal.

20. The system of claim 19, wherein the different selections correspond to different languages.
